(19) United States
(12) Patent Application Publication
(10) Pub. No.: US 2002/0125587 A1
(43) Pub. Date: Sep. 12, 2002

(54) Lens forming method

(75) Inventor: Hiroaki Fujita, Saitama-shi (JP)

Correspondence Address: LEYDIG VOIT & MAYER, LTD, 700 THIRTEENTH ST. NW, SUITE 300, WASHINGTON, DC, 20005-3960, US

(73) Assignee: FUJI PHOTO OPTICAL CO., LTD., Saitama-shi (JP)

(21) Appl. No.: 10/083,400

(22) Filed: Feb. 27, 2002

(30) Foreign Application Priority Data
Mar. 9, 2001 (JP) 2001-067040

(51) Int. Cl. B29D 11/00

(52) U.S. Cl. 264/1.1

(57) ABSTRACT

A lens forming method in which an optical material 5 is placed between an upper mold 2 and a lower mold 3, and then, with the outer peripheries of the upper mold 2 and the lower mold 3 being constrained by a trunk mold 4, the optical material 5 is compressed between the upper mold 2 and the lower mold 3, thus forming a lens, characterized in that the outside diameter of the optical material 5 is 95% to 100% of the outside diameter of the upper mold 2 and the lower mold 3.

### BACKGROUND OF THE INVENTION

1. Field of the Invention

The present invention relates to a lens forming method for forming a lens by compressing an optical material.

2. Related Background Art

For forming lenses having a relatively small diameter, a lens forming method in which a lens is formed by compressing an optical material using a lens forming mold has been known hitherto. Following is a description of this conventional lens forming method with reference to FIG. 3.

Firstly, in the lens forming mold 101, the optical material 105 with the outside diameter different from the outside diameter of an upper mold 102 and a lower mold 103 is placed between the upper mold 102 and the lower mold 103. Then, with the outer peripheries of the upper mold 102 and the lower mold 103 being constrained by a trunk mold 104, the optical material 105 is compressed between the upper mold 102 and the lower mold 103, thus forming a lens.

### SUMMARY OF THE INVENTION

However, in the lens forming described above, when the optical material 105 is placed between the upper mold 102 and the lower mold 103, the optical material 105 may be shifted away from the central axis O of the lens forming mold 101 as shown in FIG. 4 In particular, such misalignment is prone to occur in the case that the diameter of the optical material 105 is small at about 0.5 to 20 mm. If the optical material 105 is compressed in such a misaligned state, then it may be that only one side of the lens forming mold 101 is filled with the optical material 105 as shown in FIG. 4, resulting in it not being possible to form a lens 106 of the desired shape.

Moreover, if the optical material 105 is compressed in a misaligned state as described above, then even if the lens 106 is successfully formed in the desired shape, there will still be a risk of the desired optical performance not being obtained.

With the foregoing in view, it is thus an object of the present invention to provide a lens forming method in which defective lens forming is prevented, and hence a lens of desired quality can be formed.

The lens forming method according to the present invention, which is a lens forming method in which an optical material is placed between an upper mold and a lower mold, and then, in a state in which the outer peripheries of the upper mold and the lower mold are constrained by a trunk mold, the optical material is compressed between the upper mold and the lower mold, thus forming a lens, is characterized in that the outside diameter of the optical material is 95% to 100% of the outside diameter of the upper mold and the lower mold.

According to this invention, by making the outside diameter of the optical material be 95% to 100% of the outside diameter of the upper mold and the lower mold, movement of the optical material in the sideways direction is constrained by the trunk mold. When the optical material is placed between the upper mold and the lower mold, shifting of the optical material away from the central axis of the lens forming mold can thus be prevented, and hence a lens of desired quality can be formed.

Moreover, the lens forming method according to the present invention is preferably characterized in that the outside diameter of the optical material is the same as the outside diameter of the upper mold and the lower mold.

According to this invention, by making the outside diameter of the optical material be the same as the outside diameter of the upper mold and the lower mold, movement of the optical material in the sideways direction is constrained yet more strictly by the trunk mold. Shifting of the optical material away from the central axis of the lens forming mold can thus be prevented more reliably, and hence a lens of desired quality can be formed.

Moreover, the lens forming method according to the present invention is also preferably characterized in that the optical material is spherical.

According to this invention, because movement of the optical material in the sideways direction is constrained by the trunk mold as described above, shifting of the optical material away from the central axis of the lens forming mold can be prevented, and hence a lens of desired quality can be formed. Moreover, by using a spherical optical material, it becomes easy for the optical material to be filled into concave transfer surfaces provided on the upper mold and the lower mold without gaps being formed, and hence a lens having convex optical surfaces can be formed reliably.

Moreover, the lens forming method according to the present invention is alternatively preferably characterized in that the optical material is disk-shaped.

According to this invention, because movement of the optical material in the sideways direction is constrained by the trunk mold as described above, shifting of the optical material away from the central axis of the lens forming mold can be prevented, and hence a lens of desired quality can be formed. Moreover, by using a disk-shaped optical material, it becomes easy for the optical material to be filled around convex transfer surfaces provided on the upper mold and the lower mold without gaps being formed, and hence a lens having concave optical surfaces can be formed reliably.

The present invention will become more fully understood from the detailed description given hereinbelow and the accompanying drawings which are given by way of illustration only, and thus are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a drawing explaining a lens forming method according to a first embodiment of the present invention;

FIG. 2 is a drawing explaining a lens forming method according to a second embodiment of the present invention;

FIG. 3 is a drawing explaining a conventional lens forming method; and

FIG. 4 is a drawing explaining misalignment of the optical material in the conventional lens forming method.

### DESCRIPTION OF THE PREFERRED EMBODIMENTS

A description will now be given of embodiments of the present invention with reference to the drawings. Note that equivalent elements are given the same reference numeral in each of the drawings, and redundant repeated description is omitted. The ratios of dimensions in the drawings do not necessarily match the actual ratios of dimensions.

(First Embodiment)

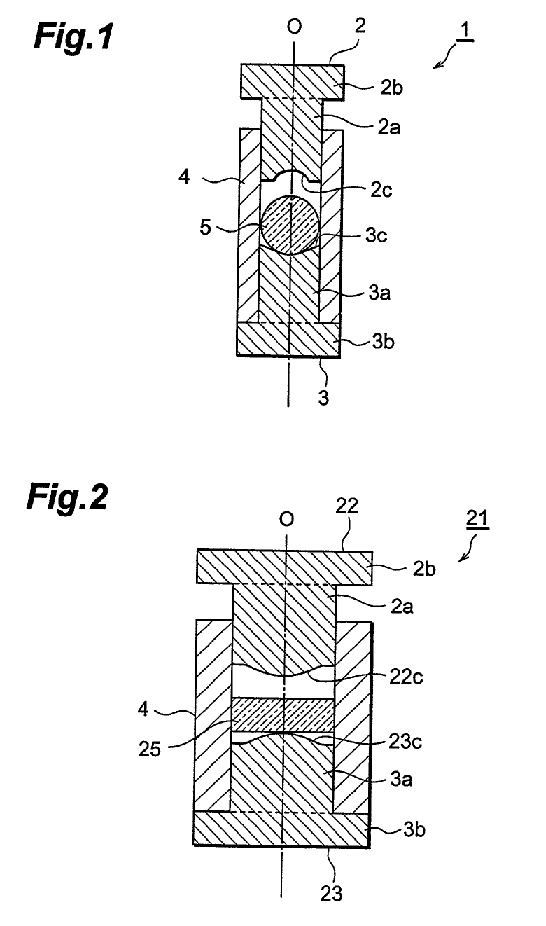

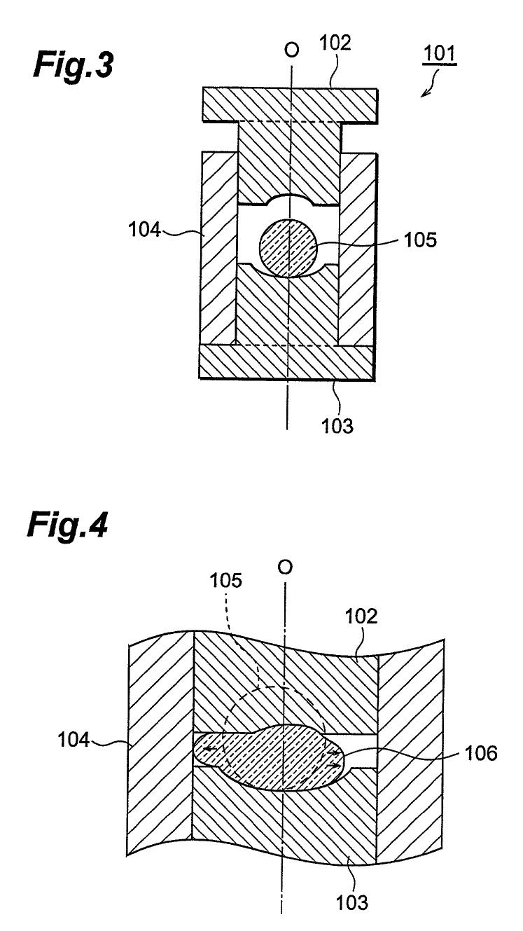

FIG. 1 is a drawing explaining the lens forming method according to a first embodiment of the present invention. Before the lens forming method is described, a description will be given of the lens forming mold 1 and the optical material 5 used in the lens forming.

As shown in FIG. 1, the lens forming mold 1 is composed of an upper mold 2, a lower mold 3 positioned below the upper mold 2, and a trunk mold 4 that constrains the outer peripheries of the upper mold 2 and the lower mold 3.

The upper mold 2 is composed of a cylindrical trunk part 2a, and a disk-shaped flange part 2b that is provided at an upper end of the trunk part 2a. At a lower end of the trunk part 2a is provided a concave transfer surface 2c for pressing against an upper surface of the optical material 5 and hence forming a convex optical surface.

The lower mold 3 is composed of a cylindrical trunk part 3a, and a disk-shaped flange part 3b that is provided at a lower end of the trunk part 3a. At an upper end of the trunk part 3a is provided a concave transfer surface 3c for pressing against a lower surface of the optical material 5 and hence forming a convex optical surface. The outside diameter of the trunk part 3a of the lower mold 3 is the same as the outside diameter of the trunk part 2a of the upper mold 2.

The trunk mold 4 has a hollow cylindrical shape, and constrains the movement of the upper mold 2 and the lower mold 3 in the sideways direction. The inside diameter of the trunk mold 4 is set as appropriate such that the trunk part 2a of the upper mold 2 and the trunk part 3a of the lower mold 3 can be pushed into and pulled out of the trunk mold 4 in the direction of the central axis O of the lens forming mold 1 without moving in the sideways direction.

A spherical body is used as the optical material 5. The outside diameter of the optical material 5 is made to be the same as the outside diameter of the trunk part 2a of the upper mold 2 and the trunk part 3a of the lower mold 3.

A description will now be given of the lens forming method.

First, in an insertion step, with the lower mold 3 inserted into the trunk mold 4, the optical material 5 is placed on the transfer surface 3c provided at the upper end of the lower mold 3, and then the upper mold 2 is inserted into the trunk mold 4. In the present embodiment, because the outside diameter of the optical material 5 is the same as the outside diameter of the trunk part 2a of the upper mold 2 and the trunk part 3a of the lower mold 3, movement of the optical material 5 in the sideways direction is constrained by the trunk mold 4. Shifting of the optical material 5 away from the central axis O of the lens forming mold 1 is thus reliably prevented.

Next, in a heating step, the lens forming mold 1 is heated such that the temperature of the optical material 5 becomes at least the transition temperature thereof. Then, in a compressing step, pressure is applied to one or both of the upper mold 2 and the lower mold 3, thus compressing the optical material 5 and hence forming a lens having convex optical surfaces. At this time, because the optical material 5 is spherical, the optical material 5 is filled into the transfer surface 2c provided on the upper mold 2 from the center of the transfer surface 2c outwards, and is filled into the transfer surface 3c provided on the lower mold 3 from the center of the transfer surface 3c outwards. The lens having convex optical surfaces can thus be formed reliably without gaps being formed between the transfer surface and the optical material 5. Next, in a cooling step, cooling is carried out, and then in a removal step the upper mold 2 is taken out and the formed lens is removed. The lens forming mold 1 is then taken back to the insertion step, and the manufacturing process is carried out once again to form another lens.

As described above, according to the lens forming method of the present embodiment, by making the outside diameter of the optical material 5 be the same as the outside diameter of the trunk part 2a of the upper mold 2 and the trunk part 3a of the lower mold 3, movement of the optical material 5 in the sideways direction is constrained by the trunk mold 4. As a result, shifting of the optical material 5 away from the central axis O of the lens forming mold 1 can be reliably prevented, and hence a lens of desired quality can be formed. Moreover, by using a spherical body as the optical material 5, it becomes easy for the optical material 5 to be filled into the concave transfer surfaces 2c and 3c provided on the upper mold 2 and the lower mold 3 respectively without gaps being formed, and hence a lens having convex optical surfaces can be formed reliably.

(Second Embodiment)

A description will now be given of the lens forming method according to a second embodiment of the present invention.

FIG. 2 is a drawing explaining the lens forming method according to the second embodiment of the present invention. Before the lens forming method is described, a description will be given of the lens forming mold 21 and the optical material 25 used in the lens forming. The differences to the first embodiment are the shape of the transfer surfaces of the upper mold and the lower mold, and the shape of the optical material.

As shown in FIG. 2, the lens forming mold 21 is composed of an upper mold 22, a lower mold 23 positioned below the upper mold 22, and a trunk mold 4 that constrains the outer peripheries of the upper mold 22 and the lower mold 23.

At a lower end of the upper mold 22 is provided a convex transfer surface 22c for pressing against an upper surface of the optical material 25 and hence forming a concave optical surface.

Moreover, at an upper end of the lower mold 23 is provided a convex transfer surface 23c for pressing against a lower surface of the optical material 25 and hence forming a concave optical surface.

A disk-shaped optical material 25 is used. The outside diameter of the optical material 25 is made to be the same as the outside diameter of the trunk part 2a of the upper mold 22 and the trunk part 3a of the lower mold 23.

A description will now be given of the lens forming method.

First, in an insertion step, with the lower mold 23 inserted into the trunk mold 4, the optical material 25 is placed on the transfer surface 23c provided at the upper end of the lower mold 23, and then the upper mold 22 is inserted into the trunk mold 4. In the present embodiment, because the outside diameter of the optical material 25 is the same as the outside diameter of the trunk part 2a of the upper mold 22 and the trunk part 3a of the lower mold 23, movement of the optical material 25 in the sideways direction is constrained by the trunk mold 4. Shifting of the optical material 25 away from the central axis O of the lens forming mold 21 is thus reliably prevented.

Next, in a heating step, the lens forming mold 21 is heated such that the temperature of the optical material 25 becomes at least the transition temperature thereof. Then, in a compressing step, pressure is applied to one or both of the upper mold 22 and the lower mold 23, thus compressing the optical material 25 and hence forming a lens having concave optical surfaces. At this time, because the optical material 25 is disk-shaped, the optical material 25 is filled around the transfer surface 22c provided on the upper mold 22 from the center of the transfer surface 22c outwards, and is filled around the transfer surface 23c provided on the lower mold 23 from the center of the transfer surface 23c outwards. The lens having concave optical surfaces can thus be formed reliably without gaps being formed between the transfer surface and the optical material 5.

Next, in a cooling step, cooling is carried out, and then in a removal step the upper mold 22 is taken out and the formed lens is removed. The lens forming mold 21 is then taken back to the insertion step, and the manufacturing process is carried out once again to form another lens.

As described above, according to the lens forming method of the present embodiment, by making the outside diameter of the optical material 25 be the same as the outside diameter of the trunk part 2a of the upper mold 22 and the trunk part 3a of the lower mold 23, movement of the optical material 25 in the sideways direction is constrained by the trunk mold 4. As a result, shifting of the optical material 25 away from the central axis O of the lens forming mold 21 can be reliably prevented, and hence a lens of desired quality can be formed. Moreover, by using a disk-shaped optical material 25, it becomes easy for the optical material 25 to be filled around the convex transfer surfaces 22c and 23c provided on the upper mold 22 and the lower mold 23 respectively without gaps being formed, and hence a lens having concave optical surfaces can be formed reliably.

(Third embodiment)

A description will now be given of the lens forming method according to a third embodiment of the present invention.

In the first and second embodiments, the lens forming method was described for the case that the outside diameter of the optical material is the same as the outside diameter of the upper mold and the lower mold. In the lens forming method according to the present embodiment, however, the outside diameter of the optical material is greater than or equal to 95% but less than 100% of the outside diameter of the upper mold and the lower mold.

Even in this case, almost the same effects can be obtained as in the lens forming method according to the first and second embodiments. That is, movement of the optical material in the sideways direction is constrained by the trunk mold, and hence when the optical material is placed between the upper mold and the lower mold, shifting of the optical material away from the central axis of the lens forming mold can be prevented, and hence a lens of desired quality can be formed.

A description will now be given of the results when lenses were formed using the lens forming method according to the present embodiment. The outside diameter of the upper mold and the lower mold of the lens forming mold used in the lens forming was 14 mm. Moreover, a spherical optical material was used.

Firstly, as examples of the lens forming method according to the present embodiment, lens forming was carried out with the outside diameter of the optical material being 98% (13.8 mm) and 95% (13.4 mm) of the outside diameter of the upper mold and the lower mold. The results were that the state of forming of the lens was extremely good in the case of 98% (13.8 mm), and satisfactory in the case of 95% (13.4 mm).

Next, as comparative examples, lens forming was carried out with the outside diameter of the optical material being 89% (12.5 mm) and 85% (12.0 mm) of the outside diameter of the upper mold and the lower mold. The results were that the state of forming of the lens was unsatisfactory in the case of both 89% (12.5 mm) and 85% (12.0 mm).

It can thus be seen that the lens forming can be carried out satisfactorily if the outside diameter of the optical material is 95% to 100% of the outside diameter of the upper mold and the lower mold.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A lens forming method in which an optical material is placed between an upper mold and a lower mold, and, in a state in which outer peripheries of said upper mold and said lower mold are constrained by a trunk mold, said optical material is compressed between said upper and lower molds, thus forming a lens;
wherein the outside diameter of said optical material is 95% to 100% of the outside diameter of said upper mold and said lower mold.

2. The lens forming method according to claim 1, wherein the outside diameter of said optical material is the same as the outside diameter of said upper mold and said lower mold.

3. The lens forming method according to claim 1, wherein said optical material is spherical.

4. The lens forming method according to claim 1, wherein said optical material is disk-shaped.
